(19) United States
(12) Patent Application Publication
(10) Pub. No.: US 2014/0336279 A1
(43) Pub. Date: Nov. 13, 2014

(54) USE OF A VAPORIZABLE COMPOSITION TO PROTECT CULTIVATED PLANTS FROM PESTS

(71) Applicant: TOTAL MARKETING SERVICES, Puteaux (FR)

(72) Inventor: Eric Bureau, Saint Hilarion (FR)

(73) Assignee: TOTAL MARKETING SERVICES, Puteaux (FR)

(21) Appl. No.: 14/365,743

(22) PCT Filed: Dec. 21, 2012
(86) PCT No.: PCT/EP2012/076593

§ 371 Date: Jun. 16, 2014

(30) Foreign Application Priority Data
Dec. 22, 2011 (FR) 1162264

(51) Int. Cl. A01N 25/04; A01N 25/30

(52) U.S. Cl. CPC A01N 25/04; A01N 25/30
USPC 514/785; 514/772

(57) ABSTRACT

The disclosure relates to the use of an oil emulsion for acaricidal, insecticidal, and antifungal treatment of the stems and leaves of a plant during the growth thereof in confined, intensive-cultivation spaces, the emulsion including water and a paraffin oil obtained from petroleum and having a boiling point of 200° C. to 450° C., a viscosity of no more than 20 mm²/s at 40° C., and an unsulfonated residue content of no less than 99% according to the ASTM D483 standard, and further including at least 20 wt % of mono- or polycyclic naphthenes, the paraffinic oil being introduced as a stable emulsifiable concentrate including water.

### CROSS-REFERENCE TO RELATED APPLICATIONS

This application is a National Phase Entry of International Application No. PCT/EP2012/076593, filed on Dec. 21, 2012, which claims priority to French Patent Application Serial No. 1162264, filed on Dec. 22, 2011, both of which are incorporated by reference herein.

### BACKGROUND AND SUMMARY

The present invention relates to the use of a vaporizable composition for protecting cultivated plants during their growth from pests. The vaporizable composition for protecting these plants has acaricidal, insecticidal and fungicidal characteristics but non-toxic for human persons and the environment. This composition is typically noxious toward pests formed for example by organisms such as oidium or “botrytis”, or further insects such as aphids, whiteflies or further mites.

Nowadays, it is customary to practice extensive cultivation of plants in greenhouses, regardless of whether these are flowers, vegetables, fruit, or further green plants. From among cultivated flowers, there are roses, chrysanthemums, tulips, alstroemerias, hydrangeas, foliage plants, lilies of the valley or further carnations. For fruit and vegetables, there are for example, tomatoes, melons and peppers. This cultivation method, in a controlled atmosphere and environment, for example confined in greenhouses, promotes development of these pests which are and prove to be a real plague for farmers.

In order to control this type of disease or massive infestation of the cultures, insecticides, acaricides and fungicides of an industrial chemical formulation are used, some of which proved to be toxic for the users. It appeared very rapidly that spraying cultures with these products may be noxious for the health of farm workers present in the greenhouses. Indeed vapours subsist after spraying the cultures and it is recommended to wait for some time before again penetrating the greenhouses. These products are also highly noxious for the environment, by direct and an indirect pollution of water of the water tables supplied by rainwater and water run-off flows from plantations as a result of sprayings.

Further it was noticed that these organisms and/or insects and/or mites may develop resistance to these products over time. In order to thwart this pest resistance, one is forced to use increasing amounts of these products, for example by increasing their concentration in the water. However, this increase tends to increase the resistance level of the pest as well as the risk of plant toxicity of the dispersions containing these products.

In order to control these pests, spraying with horticultural oils, considered as less toxic to plants, has been practiced. Thus, aqueous emulsions containing from 0.3 to 0.5% by weight of these horticultural oils were excellent means for treating infections by oidium of roses and for limiting arrival of the disease by the sprayings accomplished every 7 to 15 days. This spraying also gave the possibility of maintaining the level of mite populations below the economical impact threshold at a dose of 0.5% by weight when the treatments had begun before attaining this threshold for the species (see, for example, the article of O. Nicetic, D. M. Watson and G. A. C. Beattie in Spray oils beyond 2000 from page 387 to page 395). By horticultural oils or HMO, are meant mineral oils for which the percentage of non-sulfonated products determined by the ASTM D483 standard is greater than 92% by weight. This content of non-sulfonated product is a very important characteristic since it determines the more or less plant-toxic nature of an oil. For example, it is known that the higher the amount of non-sulfonated residues, the less it is toxic to plants, i.e. toxic for cultures upon recurrent spraying.

Generally, it is always necessary to limit or even suppress the use of products for which the plant-toxic nature becomes too significant, for example when their concentration is increased in water in order to obtain optimum efficiency against pests. This is why products are sought for which the plant-toxic nature is quasi zero for maximum efficiency for the curative and preventive aspects of diseases on plants and flowers related to the presence of the pests.

Extensive cultivation of plants, in particular of flowers intended for export is a very important market for flower producing countries such as for example certain countries of Latin America, Africa and Europe. In this case, the major problem is to maintain the flowers in perfect health from the beginning of the growth up to the point of sale, mainly on the European and American markets. It is particularly important for these flowers to protect them from all the pests.

The object of the present invention is therefore to have available non-phytotoxic products, easily dispersed as an emulsion in water before being sprayed on cultures for the period of growth of the plant. Generally, the dispersion of these products aims at covering the stem and young leaves of the plant.

The object of the present invention is therefore the use of an oil emulsion for acaricidal, insecticidal and antifungal treatment of the stems and leaves of a plant during its growth in confined intensive culture spaces, the emulsion comprising water and a paraffinic oil of petroleum origin with a boiling temperature comprised between 200 and 450° C., and a viscosity of less than or equal to 20 mm²/s at 40° C. and for which the non-sulfonated residue content according to the ASTM D483 standard is greater than or equal to 95%. The paraffinic oil is introduced as an emulsifiable concentrate comprising water. In a preferred embodiment, the paraffinic oil has a content of non-sulfonated residue according to the ASTM D483 greater than or equal to 99% and an initial distillation temperature of 250° C.

By paraffinic oil is meant an oil obtained by dearomatization/fractionation of at least one hydrocarbon cut obtained by distillation of crude oil, with a cut temperature comprised between 250 and 450° C. and/or an oil from catalytic oil-dewaxing of the same cuts, this oil having a boiling interval of less than or equal to 75° C. For the oil obtained after dearomatization/fractionation, these may be atmospheric and/or vacuum distillation cuts at temperatures comprised between 250 and 450° C., from coking and/or viscoreduction of residues. These hydrocarbon cuts will preferably be desulfurized to less than 15 ppm of sulfur either by hydrotreatment, or by hydrocracking before being dearomatized and fractionated in order to attain distillation interval cuts of less than or equal to 75° C. between 250 and 450° C., containing less than 500 ppm of aromatics. The preferred paraffinic oil comprises a hydrocarbon cut or a mixture of hydrocarbon cuts with an initial distillation temperature of at least 250° C., comprising at least 20% by weight of mono- and/or poly-cyclic naphthenes and for which the viscosity is comprised between 5 and 20 mm²/s at 40° C. Advantageously, the paraffinic oil has a viscosity comprised between 7 and 15 mm²/s at 40° C.

In a first embodiment of the use according to the invention, the emulsified water to be dispersed comprises at the most 10% by weight of paraffinic oil, preferably from 0.5% and 10% by weight and more preferentially from 1 to 10% by weight of oil. In a second embodiment of the use according to the invention, the emulsified water to be dispersed comprises at most 5% by weight of paraffinic oil, preferably from 0.1% to 5% by weight and more preferentially from 0.3 to 3% by weight of oil. In a particular embodiment, the oil emulsion comprises in a mixture with paraffinic oil, surfactants, as a stable emulsifiable concentrate comprising water, for stabilizing the emulsion prepared before spraying the cultures and during the whole period of the latter.

Among the surfactants used for stabilizing the emulsion, surfactants are preferred from the group formed by polyethoxylated oleic acids comprising up to 10, preferably from 4 to 8, ethoxylated radicals, sorbitan mono- and/or poly-carboxylates, ethoxylated sorbitan mono- and/or poly-carboxylates and/or ethoxylated glycerol mono- and/or poly-carboxylates, each carboxylate group comprising 1 to 3 carbonaceous chains with 12 to 20 carbon atoms with at least one olefinic bond, each ethoxylated group comprising from 1 to 5 ethoxylated groups and the ethoxylated alcohols corresponding to the acids. The ratio of the concentrations of the whole of the introduced surfactants and of the oil varies from 0.1:100 to 5:100. Preferably, the oil and the surfactants are introduced into the dispersion water as a stable emulsifiable concentrate comprising from 0.0001 to 1% by weight of water.

The advantage of using such paraffinic oils optionally in a mixture with surfactants is that they are not phytotoxic for the plant and the environment and the contemplated concentrations are more than 1% by weight in water. In particular, there are no toxic vapors which force the farm workers to wait for the whole of the latter to fall before entering the greenhouses after spraying the cultures with the emulsion. Further, the results with regard to the treatment of pests (mites, insects and fungal organisms) are also good or even better than those obtained with chemical products, conventional pesticides, fungicides and insecticides from the chemical industry. Further, no development of resistance to these paraffinic oils is observed as this was observed for these products, the action being purely physical unlike the customarily used conventional products.

Further, as compared with emulsions of horticultural oils, emulsions based on the paraffinic oil according to the invention are less phytotoxic, the non-sulfonated residue content of these oils being much greater than 92%. This characteristic further gives the possibility of increasing the oil concentration of the emulsion to be dispersed beyond 1% by weight in water which gives the possibility of obtaining optimum efficiency towards pests without attaining a phytotoxicity threshold, but also of reducing the time between two treatments if required.

The object of the present invention is also a method for acaricidal, insecticidal and fungicidal treatment of plant cultures in a controlled and confined atmosphere comprising:
at least one first step for emulsifying in water a paraffinic oil of petroleum origin with a temperature comprised between 200 and 450° C., with a viscosity of less than or equal 20 mm²/s at 40° C. and comprising more than 20% by weight of mono- and poly-naphthenic hydrocarbons, optionally in a mixture with surfactants and an amount of water of less than or equal to 1%,
at least one second step for spraying the emulsion obtained in the preceding step on the stem and leaves of the plant before its blooming, this spraying being repeated at least every 7 days after the first dispersion step, during the whole period of growth, preferably at least every 15 days until blooming.

According to the nature of the treatment to be applied and to the pest concentration on the plants, it may be possible to adjust the concentration of paraffinic oil in water to at least 0.1% by weight in water, more preferentially to more than 0.3% by weight, and preferably to less than 5% by weight. Preferably, the paraffinic oil concentration may be adjusted to more than 1% in water, more particularly between 1 and 2%, this concentration giving the possibility of advantageously increasing the time spent between two spraying campaigns in the greenhouses.

The examples hereafter are given for illustrating the invention i.e. for illustrating the efficiency of the invention comparatively with the prior art. Their purpose is not to limit the scope of the present invention.

### DETAILED DESCRIPTION

### EXAMPLE 1

### Treatment of Mites

The present example is directed to demonstrating the efficiency of the paraffinic oil according to the invention as an emulsion in water as compared with that of acaricidal products customarily used in greenhouses for controlling mites in particular Tetranychus cinnabarinnus or red spider, on rose cultures in greenhouses. Tests were conducted in five greenhouses. In each of them, 10 cultivation beds separated by alleys were delimited. Each bed comprises a large number of floral buds. During the tracking of the beds intended for the test, a significant infestation level of Tetranychus cinnabarinnus was detected, i.e. the presence of eggs, nymphs and adults. Each of the beds is then treated with a different emulsion by means of a piece of spraying equipment comprising a stationary piston pump, sold under the name of Robin MS 330 Eurogroup pump equipped with two hoses and six nozzles. These nozzles (Tee Jet 8001vk) are calibrated so as to send 1 liter per minute of emulsion, from 7 to 9 liters per bed, in the form of 500 micron droplets over 30 to 40 centimeters of foliage height. The program of the test includes four different treatments including Banole EC as well as comparisons of commercial treatments.

In Table 1 is gathered the description of the emulsions and solutions sprayed on the foliages of the flowers during the tests giving the possibility of comparing the efficiency of the product according to the invention with the commercial acaricidal products used. The product corresponding to the emulsions according to the invention has the following composition:
97% of paraffinic oil containing at least 20% of naphthenes and at least 30% of isoparaffinic compounds with a viscosity equal to 8.5 mm²/s and containing 99% of non-sulfonated residues.
3% by weight of a mixture of surfactants
   This product is sold under the trade name of Banole EC.

TABLE I

| | | Product | Amount of | |
|---|---|---|---|---|
| Treat- | | amount in the | sprayed | |
| ment | Nature of the | emulsion | water | |
| order | product | (wt %) | (l/ha) | Application rate |
| A | Banole EC | 1 | 1700 | 8 l/bed of 50 m² |
| B | Banole EC | 1.5 | 1700 | 8 l/bed of 50 m² |
| C | Control | 0 | 1700 | 8 l/bed of 50 m² |
| D | Commercial | X | 1700 | 8 l/bed of 50 m² |
| | acaricidal | | | |
| | product (CAP) | | | |
| E | Banole EC + | 1 + X | 1700 | 8 l/bed of 50 m² |
| | CAP | | | |

Table II gathers a description of the acaricidal products either tested alone or in a mixture (1+X) with the product of the invention.

TABLE II

| | | Product amount | |
|---|---|---|---|
| Treat- | | X in the | |
| ment | Nature of the product | emulsion (l/ha) | Application rate |
| D1 | Miteclean (pyrimediphen) | 0.3 | 8 l/bed of 50 m² |
| D2 | Polo + Oberon | 1 + 0.25 | 8 l/bed of 50 m² |
| | (diafentiuron + | | |
| | Spiromesifen) | | |
| D3 | Miteclean (pyrimediphen) | 0.3 | 8 l/bed of 50 m² |
| E1 | Miteclean (pyrimediphen) | 0.3 | 8 l/bed of 50 m² |
| E2 | Polo + Oberon | 1 + 0.25 | 8 l/bed of 50 m² |
| | (diafentiuron + | | |
| | Spiromesifen | | |
| E3 | Miteclean (pyrimediphen) | 0.3 | 8 l/bed of 50 m² |

The commercial products (Di) are prepared and applied as indicated by the vendor of the product. The emulsion prepared with a product according to the invention consists of introducing the product in water and of mixing it for three minutes. When the emulsion additionally contains an acaricide (Ei), the product according to the invention is introduced last into the emulsion.

An observation of the beds is carried out every week, but always three or four days after spraying. During the spraying of the product according to the invention, the emulsion remains stable and homogeneous, and the leaves treated with this product do not show any of the conventional sensitivity or toxicity symptoms and any change in aspect.

In Table III are gathered the results as seen with the different treatments on the initially present eggs and adults on the leaves.

TABLE III

| | Eggs | | | | | Adults | | | | |
|---|---|---|---|---|---|---|---|---|---|---|
| Treatment | D1 | D2 | D3 | D4 | Avg. | D1 | D2 | D3 | D4 | Avg. |
| A | 53 | 359 | 10 | 0 | 21.1 | 44 | 79 | 8 | 0 | 6.55 |
| B | 71 | 0 | 0 | 0 | 3.55 | 41 | 18 | 0 | 0 | 2.95 |
| E1 | 115 | 428 | 0 | 0 | 27.15 | 43 | 52 | 0 | 0 | 4.75 |
| D1 | 18 | 396 | 0 | 0 | 20.7 | 22 | 28 | 0 | 0 | 2.5 |
| C | 512 | 1295 | 2400 | 1378 | 298 | 121 | 829 | 465 | 266 | 65.5 |

The observations were made every seven days from D1 (first day of observation). The control C and the visual observation show the presence of Tetranychus cinnabarinnus or red spiders under the aspect of a brown portion of the leaf and of whitish residues. After a few days of treatment, the newly appeared leaves no longer have the characteristics related to the presence of these parasitic plagues. The eggs and the adults disappear from the leaves with time.

According to Table III, it is seen that the product according to the invention diluted to 1% and to 1.5% in water is as efficient as the customarily used acaricides. It is likely that with the product according to the invention, there is suffocation of the mites.

### EXAMPLE 1

### Treatment of Rose Oidium, Sphaeroteca panosa

The present example is directed to showing the efficiency of the paraffinic oil according to the invention as an emulsion in water as compared with that of fungicidal products customarily used in greenhouses for controlling Sphaeroteca panosa (fungus), in particular rose oidium on rose cultures in greenhouses. One operates like in Example 1 for applying the insecticides and the product according to the invention which as previously is Banole EC.

A description of the treatments carried out is given in Table IV hereafter.

TABLE IV

| Treat- | | Product amount | Amount of | |
|---|---|---|---|---|
| ment | Nature of the | in the emulsion | poured water | |
| order | product | (% wt.) | (l/ha) | Application rate |
| A′ | Banole EC | 1 | 1700 | 8 l/bed of 50 m² |
| D′ | Commercial | Y | 1700 | 8 l/bed of 50 m² |
| | fungicidal | | | |
| | product | | | |

Two commercial products were tested as a comparison: their conditions of use are given in Table V hereafter.

TABLE V

| | | Product amount Y | |
|---|---|---|---|
| | | in the emulsion | |
| Treatment | Nature of product | (l/ha) | Application rate |
| D′1 | Sodium bicarbonate | 2 | 8 l/bed of 50 m² |
| D′2 | Elosal(sulfur) | 4 | 8 l/bed of 50 m² |

The different emulsions are emulsified and dispersed as described in Example 1 with the same type of equipment. As previously in Example 1, during the spraying of the product according to the invention, the emulsion remains stable and homogeneous. And the leaves treated with this product do not exhibit any of the conventional sensitivity or toxicity symptoms and any change in aspect.

Table VI hereafter gives the results on the incidence of oidium on batches either treated with Banole EC or with commercial fungicides.

TABLE VI

| | Observa- | Observa- | Observa- | Observa- | Average |
|---|---|---|---|---|---|
| Treatment | tion 1 | tion 2 | tion 3 | tion 4 | (a) |
| A′ | 30* | 7* | 0* | 0* | 0.2887 |
| D′ | 30* | 5* | 0* | 0* | 0.3118 |

*Number of symptoms per plant
(a): average obtained over the whole of the performed observations during the test.

Although the average of the number of symptoms observed during the test is less in the Banole EC treatment as compared with the commercial fungicide treatment, a multiple rank statistic comparison at a confidence level of 95% (Fischer) suggests that the control was similar among the fungicidal treatments. The paraffinic mineral oil Banole EC applied at a dose of 1% by volume of spray was efficient, by inhibiting the development of the fungus responsible for oidium.

Banole EC oil has a series of characteristics which make it efficient in controlling diseases of plants, which explains its favorable response on the symptoms of this disease. The most important aspect is the fungistatic action from which paraffinic mineral oils benefit. In the case of Sphaeroteca panosa, this action explains the blocking of the development of the mycelium of the fungus. Moreover, the persistence and toughness of the product facilitate its permanency on the foliage and may improve its fungistatic effect, while interfering with the gas exchange processes of the pathogenic agent. Commercial products other than Banole EC may be used in the application of the invention, such as Ovispray marketed by TOTAL.

1. A method of using an oil emulsion for acaricidal, insecticidal and anti-fungal treatment, the method comprising treating at least one of stems and leaves of a plant during its growth in confined intensive culture spaces, the emulsion comprising water and a paraffinic oil of petroleum origin with a boiling temperature comprised between 200 and 450° C., with a viscosity of less than or equal to 20 mm²/s at 40° C., for which the non-sulfonated residue content according to the ASTM D483 standard is greater than or equal to 99%, and comprising at least 20% by weight of mono- or poly-cyclic naphthenes, the paraffinic oil being a stable emulsifiable concentrate comprising water.

2. The method according to claim 1, wherein the paraffinic oil has an initial distillation temperature of 250° C.

3. The use according to claim 1, wherein the paraffinic oil was obtained by dearomatisation/fractionation of at least one hydrocarbon cut obtained by distillation of crude oil, coking and/or visco-reduction of a residue with a cut temperature comprised between 250 and 450° C. and/or by catalytic dewaxing of these same cuts, and this paraffinic oil has a boiling interval of less than or equal to 75° C.

4. The use according to claim 1, wherein the paraffinic oil comprises a hydrocarbon cut or a mixture of hydrocarbon cuts with an initial distillation temperature of at least 250° C., and for which the viscosity is comprised between 5 and 20 mm²/s.

5. The use according to claim 1, wherein the paraffinic oil comprises less than 15 ppm of sulfur and less than 500 ppm of aromatics.

6. The use according to claim 1, wherein the oil emulsion comprises in a mixture with paraffinic oil as a stable emulsifiable concentrate, surfactants from the group formed by polyethoxylated oleic acids comprising up to 10 ethoxylated radicals, sorbitan mono- and/or poly-carboxylates, ethoxylated sorbitan mono- and/or poly-carboxylates and/or ethoxylated glycerol mono- and/or poly-carboxylates, each carboxylate group comprising 1 to 3 carbonaceous chains of 12 to 20 carbon atoms with at least one olefinic bond, each ethoxylated group comprising from 1 to 5 ethoxylated groups, and ethoxylated alcohols comparable with the acids.

7. The use according to claim 6, wherein a the ratio of the concentrations of the whole of the surfactants introduced and of the oil varies from 0.1:100 to 5:100.

8. The use according to claim 1, wherein the paraffinic oil and the surfactants are introduced into the water as an emulsifiable concentrate comprising from 0.0001 to 1% by weight of water.

9. The use according to claim 1, wherein the emulsion consists of 90 to 99.5% by weight of water and of 10 to 0.5% of a paraffinic oil as an emulsifiable concentrate.

10. A method for acaricidal, fungicidal and insecticidal treatment of plant cultures in a confined and controlled atmosphere comprising:
at least one step for emulsifying in the water a paraffinic oil of petroleum origin with a temperature comprised between 200 and 450° C., with a viscosity of less than or equal to 20 mm²/s and comprising more than 20% by weight of mono- and poly-naphthenic hydrocarbons, optionally in a mixture with surfactants and an amount of water of less than or equal to 1%; and
at least one second step for spraying the emulsion obtained in the preceding step on the stem and leaves of the plant before its blooming, this dispersion being repeated at least every 7 days after the first spraying during the whole period of the growth.

11. The method according to claim 10, wherein the concentration of paraffinic oil introduced as a stable emulsifiable concentrate in water is greater than 0.5% and less than 10% by weight.

12. The method according to claim 10, the concentration of paraffinic oil introduced as a stable emulsifiable concentrate in water is greater than 0.1% and less than 5% by weight.

13. The method according to claim 10, wherein the concentration of paraffinic oil in the water is comprised between 1 and 2% by weight.
